(19) United States
(12) Patent Application Publication
(10) Pub. No.: US 2025/0336420 A1
(43) Pub. Date: Oct. 30, 2025

(54) Systems and methods for processing video elements

(71) Applicant: Canva Pty Ltd, Surry Hills (AU)

(72) Inventors: Alon ZWEIG, Chatswood (AU); Phillip HAEUSLER, Melbourne (AU)

(73) Assignee: Canva Pty Ltd, Surry Hills (AU)

(21) Appl. No.: 19/187,585

(22) Filed: Apr. 23, 2025

(30) Foreign Application Priority Data
Apr. 24, 2024 (AU) 2024901162

(51) Int. Cl. G11B 27/031; G06V 10/764; G06V 10/776; G06V 10/82; G06V 20/40

(52) U.S. Cl. CPC G11B 27/031; G06V 10/764; G06V 10/776; G06V 10/82; G06V 20/41; G06V 20/49

(57) ABSTRACT

Described herein is a computer implemented method for automatically generating a trimmed video clip from a video content item. The method includes: receiving a trim request from a user device, the trim request including the video content item; determining trim parameters for the trimmed video clip, the trim parameters including a trim start time and a trim end time; generating the trimmed video clip based on the trim parameters; and causing display of the trimmed video clip on the user device.

### CROSS-REFERENCE TO RELATED APPLICATION

This application is a U.S. Non-Provisional Application that claims priority to Australian Patent Application No. 2024901162, filed Apr. 24, 2024, which is hereby incorporated by reference in its entirety.

### TECHNICAL FIELD

Aspects of the present disclosure are generally related to video content items and more particularly to systems and methos for processing video content items.

### BACKGROUND

Various computer applications for processing and editing multimedia content items, such as video clips exist. Generally speaking, such applications allow users to create and/or edit existing video content items.

A common processing task provided by such computer applications in video editing is to trim video footage. Typically, trimming refers to the process of removing unwanted portions from a video clip, for example, to improve its flow, pacing, or content. It generally involves cutting out unnecessary footage from the beginning, end, or middle of a video clip to focus on the essential content or to remove mistakes, pauses, or other distractions.

### SUMMARY

Described herein is a computer implemented method for automatically generating a trimmed video clip from a video content item. The method includes: receiving a trim request from a user device, the trim request including the video content item; determining trim parameters for the trimmed video clip, the trim parameters including a trim start time and a trim end time; generating the trimmed video clip based on the trim parameters; and causing display of the trimmed video clip on the user device.

Also described herein is a system for automatically generating a trimmed video clip from a video content item. The system includes: a processing unit; and a non-transitory computer-readable storage medium storing instructions, which when executed by the processing unit, cause the processing unit to perform a method as described above.

Further described herein is a non-transitory storage medium storing instructions executable by processing unit to cause the processing unit to perform a method as described above.

### BRIEF DESCRIPTION OF THE DRAWINGS

In the drawings:

FIG. 1 is a block diagram depicting a networked environment in which various features of the present disclosure may be implemented.

FIG. 2 is a block diagram of a computer processing system configurable to perform various features of the present disclosure.

FIG. 3 is a block diagram depicting a label generation system configured to perform various features of the present disclosure.

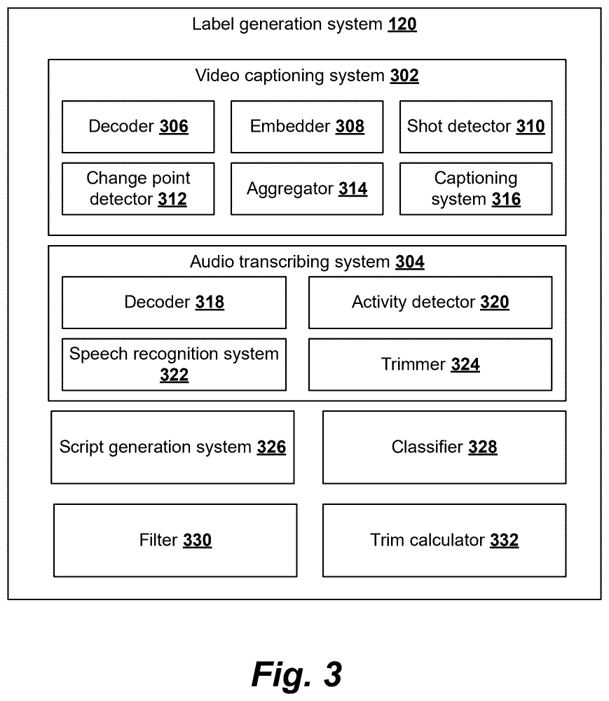

FIG. 4 is a block diagram of a trim generation system according to aspects of the present disclosure.

FIG. 5 is an example user interface according to aspects of the present disclosure.

FIG. 6 is a flowchart depicting an example method for training the trim generation system.

FIG. 7 is a flowchart depicting an example method for generating training data for training the trim generation system according to some aspects of the present disclosure.

FIG. 8 is a flowchart illustrating an example method for automatically generating labels for training data according to some aspects of the present disclosure.

FIG. 9 is a flowchart illustrating an example method for generating a transcript of audio according to aspects of the present disclosure.

FIG. 10 is a flowchart illustrating an example method for generating captions for one or more frames of video content according to aspects of the present disclosure.

FIG. 11 is a flowchart illustrating an example method for automatically trimming a video content item according to aspects of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form to avoid unnecessary obscuring.

Video trimming is generally performed manually using a suitable video editing computer application. The computer application typically provides tools for trimming, such as reviewing the video footage and identifying any useful, interesting, or narratively important content and then manually selecting the start and end timing of such content. This can be achieved by dragging markers on a video timeline to set precise points. Once the beginning and end of the content is identified, the user may utilize the editing application to delete the remainder of the video footage, leaving only the desired segment, which is referred to as a trimmed video clip herein.

It will be appreciated that this process can be challenging and time consuming—especially when numerous video content items have to be analysed and trimmed. For example, accurately identifying the start and end times of a trimmed video clip can be difficult. Further, users may need to review the trimmed video clip numerous times to ensure smooth transitions and proper pacing. They may involve further adjustments by repositioning the start and end timing.

Aspects of the present disclosure are directed to systems and methods for automatically analysing and trimming video content items to generate one or more trimmed video clips. To do so, aspects of the present disclosure employ a machine learning model that has been trained to analyse a video clip and identify trim parameters such as start and end timings of a trim, frames within the video content item that should be included in the trimmed video clip and frames that should not be included in the trimmed video clip. These identified trim parameters are then used by the presently disclosed systems and methods to automatically trim the video content item to generate the trimmed video clip. The systems and methods disclosed herein can then display the trimmed video clip in a user interface displayed on a user device.

Further, aspects of the present disclosure are also directed to systems and methods for training the machine learning model to determine the trim parameters.

These and other aspects of the present disclosure will now be described in detail with reference to the following figures.

### Network Architecture and System

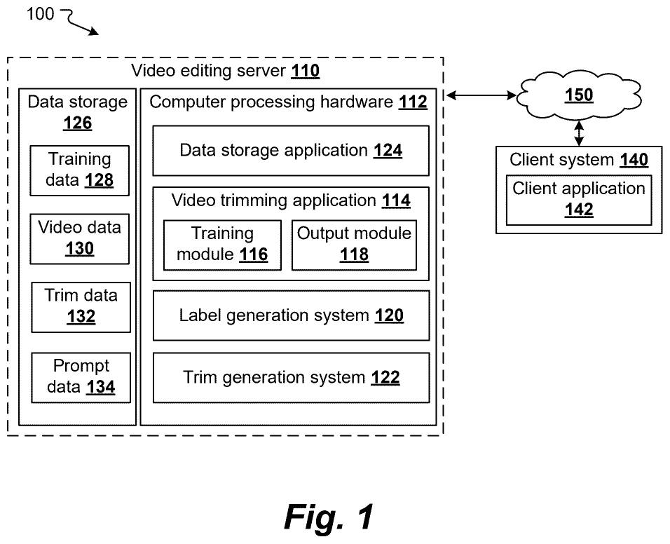

FIG. 1 is a block diagram depicting a networked environment 100 in which various features of the present disclosure may be implemented. The environment 100 includes server- and client-side applications, which operate together to perform the processing described herein. In particular, it includes a video editing server 110 and a client system 140, which communicate via one or more communications networks 150 (e.g., the Internet).

The video editing server 110 includes computer processing hardware 112 (discussed below) on which applications that provide server-side functionality to client applications such as client application 142 (described below) execute. In the present example, the video editing server 110 includes a video trimming application 114, a label generation system 120, a trim generation system 122, and a data storage application 124.

The video trimming application 114 may execute to provide a client application endpoint that is accessible over the communications network 150. For example, where the video trimming application 114 serves web browser client applications, the video trimming application 114 will be hosted by a web server which receives and responds (for example) to HTTP requests. Where the video trimming application 114 serves native client applications, the video trimming application 114 may be hosted by an application server configured to receive, process, and respond to specifically defined API calls received from those client applications. The video editing server 110 may include one or more web server applications and/or one or more application server applications allowing it to interact with both web and native client applications.

The video trimming application 114 facilitates various functions related to editing video content items in the video editing server 110. This may include, for example, uploading, viewing, editing, storing, trimming, and/or retrieving video content items. The video trimming application 114 may also facilitate additional functions that are typical of server systems—for example user account creation and management, user authentication, and/or other server-side functions. Each of these functionalities may be provided by individual applications, e.g., an account management application (not shown) for account creation and management, a video creation application (not shown) to aid users in creating, editing, storing video content items, a management application (not shown) that is configured to maintain and store video content items and trimmed video clips in the data storage, etc.

In addition to these applications, the video trimming application 114 includes a training module 116, and an output module 118. The training module 116 is configured to generate training data and train the trim generation system 122 based on the generated training data. For example, it may train the trim generation system 122 until it can generate trim parameters sufficiently accurately for any given video content item. The output module 118 is configured to receive the trim parameters from the trim generation system 122 and render trimmed video clips for display on one or more display devices of client system 140. Operations of these modules will be described in more detail later.

The label generation system 120 is configured to receive training data, i.e., numerous video content items, and automatically generate trim parameters for the video content items. Operation and training of this system will be described in more detail later.

The trim generation system 122 includes one or more trained machine learning models that receive a video content item and generate trim parameters including start and end timing and a list of frames of the video content item to be included in a trimmed video clip. Operation and training of this system will be described in more detail later.

Although the label generation system 120 and the trim generation system 122 are depicted as part of the video editing server 110, in some embodiments, one or more of these may be an independent application hosted by one or more different server systems.

The data storage application 124 executes to receive and process requests to persistently store and retrieve data relevant to the operations performed/services provided by the video trimming application 114, the label generation system 120 and/or the trim generation system 122. Such requests may be received from the video trimming application 114, the label generation system 120, and/or the trim generation system 122, and/or (in some instances) directly from client applications such as 142.

The data storage application 124 may, for example, be a relational database management application or an alternative application for storing and retrieving data from data storage 126. Data storage 126 may be any appropriate data storage device (or set of devices), for example one or more non-transitory computer readable storage devices such as hard disks, solid state drives, tape drives, or alternative computer readable storage devices.

In video editing server 110, the video trimming application 114 persistently stores data to data storage 126 via the data storage application 124. In alternative implementations, however, the video trimming application 114 may be configured to directly interact with data storage devices such as 126 to store and retrieve data (in which case a separate data storage application 124 may not be needed). Furthermore, while a single data storage application 124 is described, the video editing server 110 may include multiple data storage applications.

The data storage 126 maintains data relevant to the operations performed/services provided by the video trimming application 114, the label generation system 120 and/or the trim generation system 122. In some embodiments, the data storage 126 includes a training data library 128 that stores training data required to train the trim generation system 122. The training data may include multiple training data records.

The data storage 126 also maintains video data 130 for a set of video content items made available by the video editing server 110 or saved by users at the video editing server 110. The data storage further stores trim data 132 for trimmed video clips generated by the video trimming application 114. The trim data may include the trim parameters determined by the trim generation system 122. Further still, the data storage 126 may store prompt data 134 that may be used by the label generation system 120 to automatically determine trim parameters for training data records. Some of the data stored by the data storage 126 will be described in detail in the following sections.

Although a single data storage 126 is displayed in FIG. 1, it will be appreciated that the data storage 126 may include multiple individual data stores for storing different types of data. For example, one data store may be used for user account data, another for design data, another for design asset data, another for training data, and so forth.

As noted, the video trimming application 114, the label generation system 120 and/or the trim generation system 122 run on (or are executed by) computer processing hardware 112. Computer processing hardware 112 includes one or more computer processing systems. The precise number and nature of those systems will depend on the architecture of the video editing server 110.

For example, in one implementation multiple instances of the video trimming application 114, the label generation system 120, and/or the trim generation system 122 may run on their own dedicated computer processing systems. In another implementation, two or more instances of the video trimming applications 114, the label generation system 120 and/or the trim generation system 122 may run on a common/shared computer processing system. In a further implementation, video editing server 110 is scalable in which application instances (and the computer processing hardware 112—i.e. the specific computer processing systems required to run those instances) are commissioned and decommissioned according to demand—e.g., in a public or private cloud-type system. In this case, video editing server 110 may simultaneously run multiple instances of each application 114-124 (on one or multiple computer processing systems) as required by client demand. Where the video editing server 110 is a scalable system, it will include additional applications to those illustrated and described. As one example, the video editing server 110 may include a load balancing application (not shown) which operates to determine demand, direct client traffic to the appropriate application instance (where multiple applications have been commissioned), trigger the commissioning of additional applications (and/or computer processing systems to run those applications) if required to meet the current demand, and/or trigger the decommissioning of server applications (and computer processing systems) if they are not functioning correctly and/or are not required for current demand.

Communication between the applications and computer processing systems of the video editing server 110 may be by any appropriate means, for example direct communication or networked communication over one or more local area networks, wide area networks, and/or public networks (with a secure logical overlay, such as a VPN, if required).

The present disclosure describes various operations that are performed by applications of the video editing server 110. However, operations described as being performed by a particular application (e.g., training module 116) could be performed by one or more alternative applications, and/or operations described as being performed by multiple separate applications could in some instances be performed by a single application.

Client system 140 hosts a client application 142 which, when executed by the client system 140, configures the client system 140 to provide client-side functionality/interact with the video editing server 110. Via the client application 142, and as discussed in detail below, a user can access the various techniques described herein—e.g., the user can upload or select video content items, view and/or preview video content items, request trimming of a video content item, review a trimmed video clip, edit, or publish one or more trimmed video clips, etc. Client application 142 may also provide a user with access to additional editing related operations, such as creating, editing, playing, saving, publishing, sharing, and/or other video related operations.

The client application 142 may be a general web browser application which accesses the video trimming application 114 and/or the data storage application 124 via an appropriate uniform resource locator (URL) and communicates with these server applications via general world-wide-web protocols (e.g. HTTP, HTTPS, FTP). Alternatively, the client application 142 may be a native application programmed to communicate with the video trimming application 114 and/or the data storage application 124 using defined application programming interface (API) calls and responses.

A given client system such as 140 may have more than one client application 142 installed and executing thereon. For example, a client system 140 may have a (or multiple) general web browser application(s) and a native client application.

The present disclosure describes some method steps and/or processing as being performed by the client application 142. In certain embodiments, the functionality described may be natively provided by the client application 142 (e.g. the client application 142 itself has instructions and data which, when executed, cause the client application 142 to perform the described steps or functions). In alternative embodiments, the functionality described herein may be provided by a separate software module (such as an add-on or plug-in) that operates in conjunction with the client application 142 to expand the functionality thereof.

While the embodiments described below make use of a client-server architecture, the techniques and processing described herein could be adapted to be executed in a stand-alone context—e.g. by an application (or set of applications) that run on a computer processing system and can perform all required functionality without need of a server environment or application.

The techniques and operations described herein are performed by one or more computer processing systems.

By way of example, client system 140 may be any computer processing system which is configured (or configurable) by hardware and/or software—e.g. client application 142—to offer client-side functionality. A client system 140 may be a desktop computer, laptop computer, tablet computing device, mobile/smart phone, or other appropriate computer processing system.

Similarly, the applications of the video editing server 110 are also executed by one or more computer processing systems (the computer processing hardware 112). Server computer processing systems will typically be server systems, though again may be any appropriate computer processing systems.

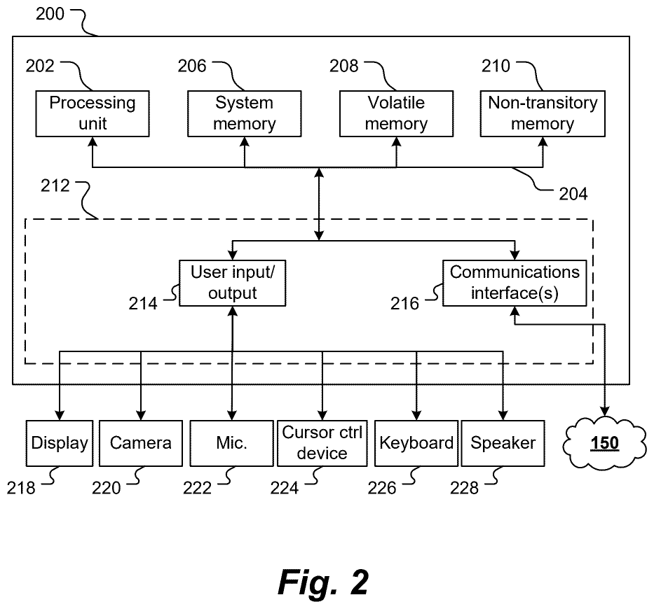

FIG. 2 provides a block diagram of a computer processing system 200 configurable to implement embodiments and/or features described herein. System 200 is a general-purpose computer processing system. It will be appreciated that FIG. 2 does not illustrate all functional or physical components of a computer processing system. For example, no power supply or power supply interface has been depicted, however system 200 either carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random-access memory such as one or more DRAM modules), and non-transitory memory 210 (e.g. one or more hard disk or solid-state drives).

System 200 also includes one or more interfaces, indicated generally by 212, via which system 200 interfaces with various devices and/or networks. Other devices may be integral with system 200 or may be separate. Where a device is separate from system 200, the connection between the device and system 200 may be via wired or wireless hardware and communication protocols and may be a direct or an indirect (e.g. networked) connection.

Generally speaking, and depending on the system in question, devices to which system 200 connects include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

Where client application 142 operates to display controls, interfaces, or other objects, client application 142 does so via one or more displays that are connected to (or integral with) system 200—e.g. display 218. Where client application 142 operates to receive or detect user input, such input is provided via one or more input devices that are connected to (or integral with) system 200—e.g. touch screen, touch screen display 218, cursor control device 224, keyboard 226, and/or an alternative input device.

As another example, where system 200 is a server computing device it may be remotely operable from another computing device via a communication network (e.g., network 150). Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 150 of environment 100 (and/or a local network within the video editing server 110). Via the communications interface(s) 216, system 200 can communicate data to and receive data from networked systems and/or devices.

System 200 stores or has access to computer applications (which may also be referred to as computer software or computer programs). Such applications include computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example and referring to the networked environment of FIG. 1 above, video editing server 110 includes one or more systems which run a video trimming application 114, a data storage application 124, the label generation system 120 and/or the trim generation system 122. Similarly, client system 140 runs a client application 142.

In some cases, part or all of a given computer-implemented method will be performed by system 200 itself, while in other cases processing may be performed by other devices in data communication with system 200.

### Label Generation System

As described previously, the label generation system 120 is configured to analyse training video content items and automatically generating one or more trim parameters for these video content items, such as a start and end time for a trimmed video clip. To do so, it includes a video captioning system 302 that is configured to analyse a video component of the video content items and generate captions for one or more frame identified in the video, and an audio transcribing system 304 that is configured to analyse an audio component of the video content item and generate text for any speech identified in the audio component.

To generate the captions, the video captioning system 302 further includes a video decoder 306 that is configured to identify individual frames in the video content items, and an encoder 308 that is configured to convert each video frame into a vector embedding. The video captioning system 302 further includes a shot detector 310 that is configured to identify shot boundaries in the video content item. Each shot is a continuous sequence of frames taken by a camera. Edited videos are usually composed of multiple shots stitched together. Identifying individual shots in the video content item helps the captioning system understand how a video content item is changing.

The video captioning system 302 further includes a change point detector 312, an aggregator 314, and a captioning system 316. The change point detector 312 is configured to identify a minimum set of key frames in the video content item where sufficient change has occurred. This allows the video captioning system 302 to minimize the number of frames which are captioned. The aggregator 314 combines the shots and the change point frames to generate a set of shots and their corresponding change point frames. Finally, the captioning system 316 is configured to generate a caption for each frame in the set of shots and their corresponding change point frames. Captions for the frames may be generated in any appropriate way, for instance by a machine learning model or an alternative processing technique. For example, the frames may be provided to a trained machine learning model with visual capabilities, such as GPT-4, with instructions, and the trained machine learning model may generate captions for the entire video content item, the shots in the video content item, and the change point frames in the video content item.

To generate text for any speech identified in the audio component, the audio transcribing system 304 includes a decoder 318, an activity detector 320, a speech recognition system 322 and a trimmer 324. The decoder 318 converts the audio component of the video content item into a format that can be further processed by the audio transcribing system 304. This may include normalizing, sampling, and decoding the audio file. The activity detector 320 identifies any speech in an audio file. The trimmer 324 trims the video content item to segments where speech is detected and the speech recognition system 322 predicts the words spoken in the trimmed speech segments of the audio component.

The label generation system 120 further includes a script generation system 326 that receives the captioned video component and the transcribed audio component from the video captioning system 302 and the audio transcribing system 304, respectively, and generates a timestamped script based on both these pieces of data. The timestamped script includes any dialogs in the video content item and any captions associated with shots and frames in the video content item.

In addition to the above, the label generation system 120 includes a classifier 328 and a filter 330. The classifier 328 may be configured to analyse the timestamped script to determine a classification for the video content item. The classifier 328 may be a trained machine learning model that receives the video script along with instructions to classify the video script in one of a predetermined number of categories and then classifies the video script in one of the predetermined categories. The filter 330 may be configured to discard any video content items that are classified under one or more predetermined exclusion categories.

The label generation system 120 further includes a trim calculator 332 that is configured to analyse the classified and/or filtered timestamped scripts and identify start and end times for a corresponding trimmed video clip that includes the most relevant content from the classified and/or filtered video content item.

Operation of these components will be described in detail later.

### Trim Generation System

The trim generation system 122 includes a machine learning model that is trained to label each frame of an input video content item as within a trim or outside the trim and predict a start and end time of the trim.

In one example, the machine learning model uses an encoder only transformer model as a base and applies one or more predictor heads on the encoder only transformer model. In other examples, any other suitable machine learning models such as an encoder-decoder transformer model, a recurrent neural network architecture, or a convolutional neural network architecture, can be utilized without departing from the scope of the present disclosure.

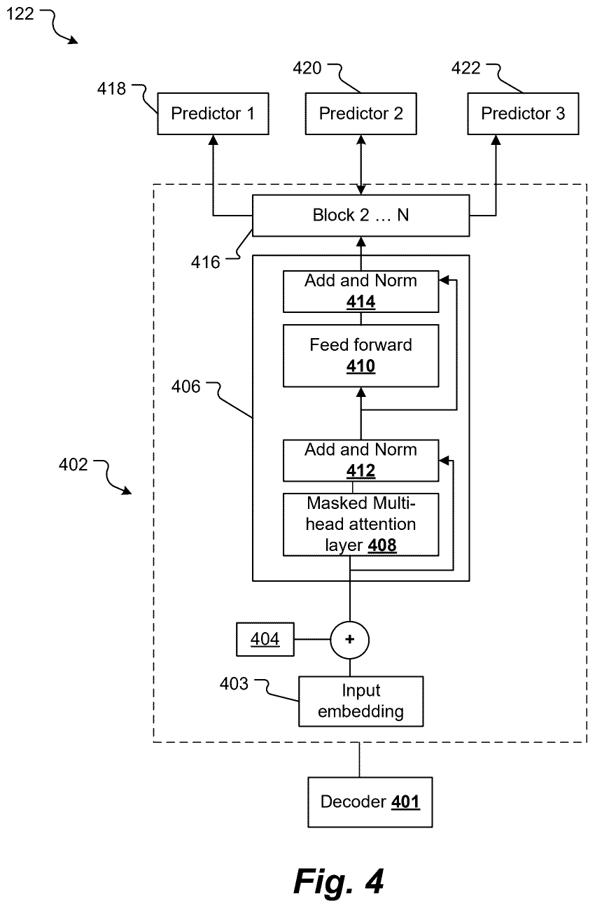

FIG. 4 illustrates an example trim generation system 122 using an encoder-only transformer architecture. The input to the system 122 is a video content item. The output of the system 122 is the trim parameters. The system 122 includes a decoder 401 that is configured to convert the video content item into individual frames (e.g., by sampling the video content item at a predetermined sampling rate), an encoder transformer 402, and a plurality of predictors 418-422. The primary function of the encoder transformer 402 is to process input sequences, extract meaningful representations and encode them for downstream prediction by the predictors 418-422.

The encoder transformer 402 includes an input embedding layer 403 before encoder layers 406. The embedding layer 403 converts each frame of the video content item into vector embeddings. These embeddings capture the semantic information of each input frame and server as the initial representations of the frames for further processing.

The encoder transformer 402 also includes a positional encoder 404 that provides information about the position of each frame in the input. Traditional machine learning models, such as neural networks, do not inherently understand the order of inputs. To address this challenge, positional encoding can be used to encode the position of each frame in the input sequence as a set of numbers. By incorporating positional encoding into the transformer 402, the trim generation system 122 can more effectively understand the order of frames in the video and generate more accurate outputs. This positional information is combined with the vector embeddings from the embedding layer 403 before it is provided to the first encoder block 406.

In some embodiments, the position encoder 404 uses sinusoidal positional embeddings. These are a specific type of positional encoding that represents the position of each token using sinusoidal functions. In sinusoidal positional embeddings, the position of each token is encoded in the input sequence using a set of learned sinusoidal functions with different frequencies and phases. For example, Each position i in the input sequence is assigned a unique vector of positional embeddings PEᵢ and each element j of the positional embedding vector PEᵢ is computed using sinusoidal functions:

$${PE}_{i , 2 j} = sin ( i / 1000 {0}^{{2}_{j} / {d}^{model}} ) \\ {PE}_{i , 2 j + 1} = cos ( i / 1000 {0}^{{2}_{j} / {d}^{model}} )$$

Where: i is the position of the token in the sequence. j indexes the elements in the positional embedding vector, and d_{model} is the dimensionality of the model. By using sinusoidal functions with different frequencies, the positional embeddings ensure that the model can learn to distinguish between tokens based on their positions in the sequence.

Each encoder block 406 includes a multi-head self-attention layer 408 including multiple ‘heads’. Each head has its own weights and lets the transformer 402 focus on different parts of the input when generating each token. Each head of the attention layer 408 transforms the input embeddings into queries, keys, and values to compute attention scores between pairs of tokens in the input data. The attention scores indicate the importance of each token relative to others in the input data. The attention scores may be utilized by these layers 408 to compute weighted sums of the values, resulting in contextualized representations for each token in the input data. The output from each head is concatenated and passed through a linear layer. The multi-head attention layer is unmasked, in that the encoder can see the entire input. This allows later frames from attending to subsequent positions such that each token in a sequence is influenced not only by previous tokens but also by future tokens.

Each encoder block 406 also includes a feedforward neural network layer 410 that learns complex interactions and features from the representations generated by the self-attention layers 408. The self-attention 408 and feedforward neural network layers 410 are followed by residual connection and normalization layers 412, 414 that add the output of each layer to the input of that layer, allowing gradients to flow directly through the encoder transformer 402 during training and normalize the outputs of that layer to stabilize training and improve convergence. The output of the final encoder block 406 is a set of rich representations that capture both local and global dependencies within the input data vectors, each representing the input sequence with a rich contextual understanding.

Further still, the transformer 402 includes a layer normalization (not shown) before the attention layers 408 that applies layer normalization to the input embeddings or representations before passing them through the attention layers 408. This helps stabilize the training process and improve the convergence of the model. In particular, it helps to stabilize the activations of each layer, making them less sensitive to changes in scale and distribution. This can help prevent issues like vanishing or exploding gradients during training. The layer norm normalizes the activations of each layer across a feature dimension independently, typically by subtracting the mean and dividing by the standard deviation of the activations.

It will be appreciated that the transformer 402 may include additional and/or alternative layers (e.g., including pre-processing and post processing layers). Further, it will be appreciated that a transformer architecture is an example of the type of LLM that can be trained to generate designs according to embodiments of the present disclosure and that alternative deep learning model architectures such as the encoder-decoder transformer model, convolutional neural networks, etc., may be utilized in the trim generation system 122 without departing from the scope of the present disclosure.

The encoder transformer 402 is a non-causal transformer. In non-causal transformers the self-attention mechanism in the encoder operates in a non-causal manner—that is, each token in the input sequence can attend to both preceding and succeeding tokens, enabling bidirectional information flow within the model. The bi-directional context is beneficial in capturing richer representations of the input sequence as it allows the model to consider the entire input sequence when generating the representation of the input sequence. To make the transformer 402 non-causal, masking or causality constraints are removed from the self-attention mechanism in the encoder, allowing tokens to attend to both preceding and succeeding tokens.

The predictors 418-422 are the output layers of the trim generation system 122 and are responsible for making predictions or task-specific outputs based on the encoded representations generated by the encoder transformer 402. Each predictor is designed to perform a specific task, and includes one or more additional layers (such as fully connected layers) followed by appropriate activation functions. These layers transform the encoded representations into the desired output format for the task at hand.

Accordingly, each predictor 410-422 is configured to receive the output from the encoder transformer 402 and utilize this to perform a specific task. For example, one of the predictors, e.g., classification predictor 418, predicts a label (e.g., 0 or 1) for each frame in the input, where 0 indicates that the frame does not form part of the trimmed video clip and 1 indicates that the frame forms part of the trimmed video clip. Another predictor, e.g., start predictor 420, predicts a number between 0-1, which indicates the start time of the trimmed video clip and the third predictor, e.g., end predictor 422, may predict a number between 0-1, which indicates the end time of the trimmed video clip.

In one embodiment, the classification predictor 418 includes a fully connected neural network layer followed by a softmax activation function to predict the probability distribution over the two different classes—0 and 1.

The start and end predictors 420 and 422 may be Multi-Layer Perceptron (MLP) predictors, which are a type of neural network. Each MLP predictor includes multiple layers of neurons (nodes) arranged in a feedforward manner, where each neuron in a layer is connected to every neuron in the subsequent layer. The typical architecture of an MLP predictor includes an input layer, hidden layers, and an output layer. The neurons in the input layer represent the input features or encoded representations of the input data (i.e., the output from the encoder transformer 402), the hidden layers are intermediate layers between the input and output layers. Each hidden layer includes multiple neurons, and each neuron is connected to every neuron in the previous and next layers. The hidden layers enable the model to learn complex patterns and representations from the input data. Neurons in the output layer represent the output of the model. The number of neurons in the output layer depends on the type of prediction task. For regression tasks, there is usually a single neuron representing the predicted numerical value.

Each neuron in an MLP predictor applies an activation function to the weighted sum of its inputs to introduce non-linearity into the model, enabling it to learn complex relationships in the data. Common activation functions used in MLPs include the sigmoid function, tanh function, and rectified linear unit (ReLU) function.

These predictors 418-22 are trained along with the encoder layers 406 of the transformer 402 in an end-to-end fashion using supervised learning. During training, the parameters of both the encoder layers 406 and the predictors 418-422 are updated to minimize the task-specific loss function, which measures the discrepancy between the predicted outputs and the ground truth labels or targets.

In some embodiments, a layer normalization (not shown) may be applied to the input of the predictors 418-422. This layer normalization may be similar to the layer normalization applied before the self-attention layers and therefore will not be described in detail again.

### User Interface

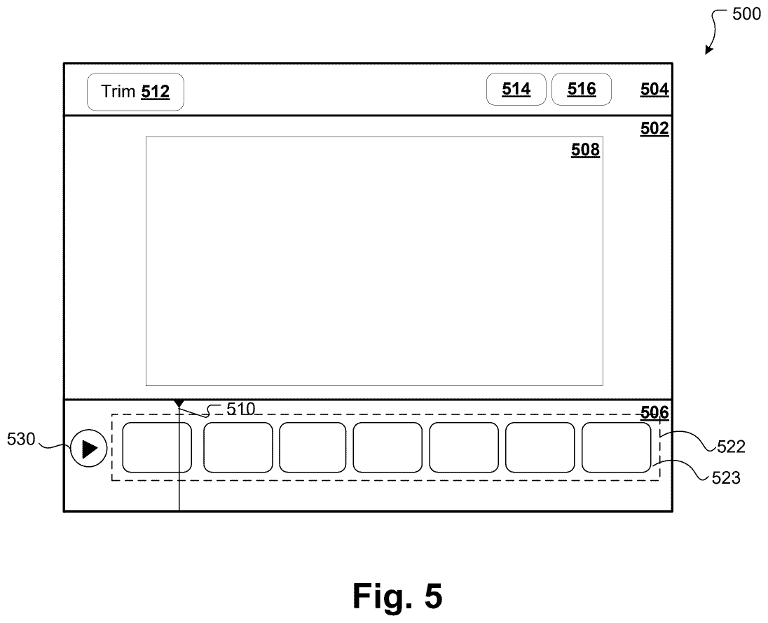

In the present disclosure, the client application 142 configures the client system 140 to provide an editor user interface 500 (UI). Generally speaking, the editor UI 500 allows a user to preview, view, create, edit, and output video content items. FIG. 5 provides a simplified and partial example of an editor UI 500. In this example, the UI 500 is a graphical user interface (GUI).

UI 500 includes a preview region 502, a control region 504, and a timeline region 506.

The preview region 502 displays a still 508 from a video content item that corresponds to a particular position (time) in the video content item. The particular time that the still 508 corresponds to is indicated by a playhead 510, which is displayed in the timeline region 506. In the embodiment illustrated by FIG. 5, the still 508 corresponds to the playback position that is at the start of the video content item.

The control region 504 includes controls that allow a user to edit and/or adjust characteristics of the video content item. In the example illustrated in FIG. 5, the control region 504 three controls 512-516 (though may have additional or fewer additional controls). Control 512 is an auto trim control, which when selected automatically trims the video content item displayed in the preview region 502 using method 1100. Once the video content item is trimmed, the user interface 500 may also display visualize the trim region (e.g., in the timeline region).

Some controls may be permanently displayed in the control region 504. For example, control 516 may be a permanently displayed ‘publish’ control, which a user can activate to publish, share, or save the video content item currently being worked on. When the video content item is saved, a new video content item record can be generated and saved in the data storage 126. As another example, a particular control (e.g., 514) may be a toggle control allowing a user to display or hide the timeline region.

The timeline region 506 is used to display a video timeline 522. The video timeline 522 includes scene previews 523 that correspond to scenes of the video content item.

In the present example, the timeline region 506 also has a play control 530. Activation of the play control 530 by a user causes the video content item to play from the position (time) indicated by the playhead 510 (e.g. in preview region 502). Once the play control 510 has been activated, it turns into a pause control (not shown), which when activated causes the video content item to pause playback. When the video content item is playing, a progress indicator is displayed in the timeline region 506 indicating the current play position of the video content item. The progress indicator may be playhead 510. A user may be able to interact with the playhead 510 (via the client application 142 on client system 140) to move the playhead 510 and, therefore, playback of the video content item to a particular time.

Alternative interfaces, with alternative layouts and/or alternative tools and functions, are possible. For example, the editor GUI 500 typically include many other controls that permit designs to be created, edited (by creating/adding design elements such as images, text, videos, and/or other elements), and output (e.g. saving to local memory, a data store such a 126, printing, publishing via social media, and/or other means) in various ways.

It will be appreciated that in UI 500, selection of the various user input controls can be done in various ways. For example, a user may select the one or more interactive controls using a keyboard or mouse. Alternatively, a user may select an interactive control by speaking. In such cases, words are captured by a microphone (e.g., microphone device 222) and converted to text using appropriate speech-to-text software and then used to select the one or more interactive controls.

### Training Trim Generation Model

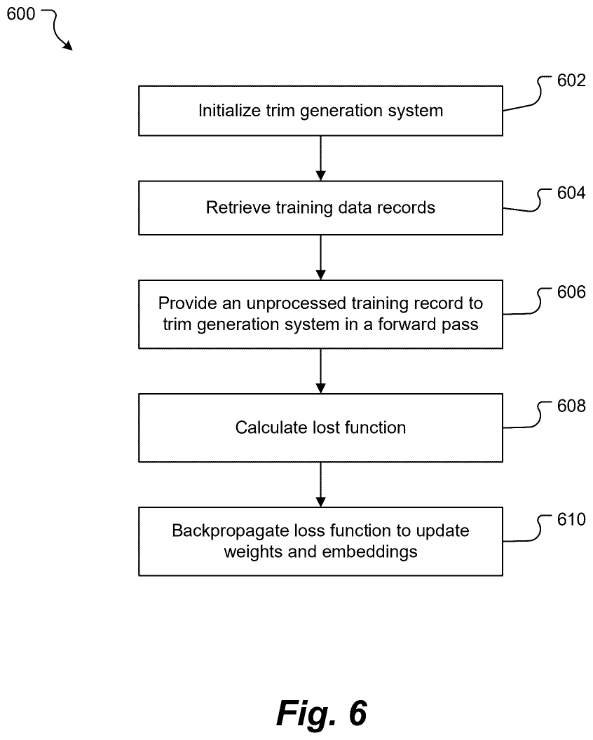

Turning to FIGS. 6-11, computer implemented methods for training the trim generation system 122 and using the trim generation system 122 will be described. As noted above, the operations of methods 600-1100 will be described as being performed by the client application 142, the video trimming application 114 and other applications running on the client system 140, and the video editing server 110. In alternative embodiments, however, the processing described may be performed by one or more alternative applications running on the client system 140, the server hardware 112 and/or other computer processing systems.

As described previously, the trim generation system 122 is trained to automatically trim video content items to generate trimming parameters. During training, the trim generation system learns four vocabulary tokens—two special pooling tokens that predict the start and end time of the trim, padding tokens, and an end of sequence token.

Further, during the training process, the weights of various layers of the trim generation system 122 are learnt to enable these layers to accurately learn the vocabulary and generate the trim parameters.

A method for training the trim generation system 122 will now be described with reference to FIG. 6

Generally speaking, an adaptive moment estimation (Adam) methodology is adopted for training the trim generation system 122. This technique combines two other optimization algorithms—Adaptive Gradient Algorithm and Root Mean Square Propagation. It maintains a per-parameter learning rate that adapts during training and incorporates momentum, which helps accelerate the optimization process.

The method 600 commences at step 602, where the trim generation system 122 is initialized. This may include setting the weights of the various layers and sub-systems of the trim generation system 122. In particular, the layers of the encoder transformer 402 may be set to arbitrary values.

Further, new special tokens are added to the embedding space of the encoder transformer 402. The special tokens added to the embedding space include a start trim pooling token, an end trim pooling token, a padding token, and an end-of-sequence token. The start trim and end trim are special pooling tokens.

Pooling tokens are used to aggregate information from multiple tokens in a sequence into a single, fixed-size vector. This pooled representation generally captures the overall meaning or context of the entire input sequence and generates a single representation of the entire sequence. These special tokens serve as markers for the model to understand the beginning and end of a sequence, as well as to aggregate information from all tokens in the sequence.

For the special tokens, the encoder transformer 402 is trained to learn the meaning of the tokens and the relationships between those tokens. Accordingly, the tokens are initially added with random vector embeddings and these are adjusted during the training.

The weights of each of the predictors 418-422 may also be set to random values or to predetermined values. As described previously, these weights typically determine the output generated by the predictors. Additionally, the predictors may include bias terms, which are constants added to the weighted sum of inputs. Biases help the predictors learn the correct output even when all input values are zero. In case predetermined values are utilized, the predetermined weight and bias values for the various predictors may be adapted from existing predictor models. When initializing the predictors with random weights and biases, each weight and bias parameter in these layers may be set to a random value. These random values may be selected from a distribution with a mean of 0 (such as a normal distribution or a uniform distribution) and a small standard deviation.

Initializing the weights randomly helps break symmetry and prevents neurons in the predictors from computing the same function. If all weights were initialized to the same value, the neurons would produce identical outputs during forward propagation, and there would be no diversity in the behaviours of the various predictors. Random initialization ensures that neurons learn to extract different features from the input data.

At step 604, the training module 116 retrieves training data from the training data library 128. The training data may be in the form of training data records. The number of training data records utilized to train the trim generation system 122 may vary. In some embodiments about 50,000 training records may be utilized and retrieved at this step. Each training data record is made up of two special pooling tokens, followed by padding tokens, then the sequence of embeddings for the video, more padding tokens, and an end of sequence token. In one example, each training data record may include a sequence as follows—

$$〈 start\_pool 〉 〈 end\_pool 〉 ( 〈 pad 〉 * p s ) ( 〈 image 〉 * seq\_len ) ( 〈 pad 〉 * pe ) 〈 eos 〉 ,$$

Where <start_pool> is the start trim special pooling token and predicts the trim start time as a value between 0 and 1. <end_pool> is an end trim special pooling token that predicts the trim end time as a value between 0 and 1. <pad>*ps and <pad>*pe are placeholder sequences of padding tokens that are used for data augmentation. <image>*seq_len is the sequence of video frame embeddings, one per frame of the video, and <eos> is the special end of sequence token.

At step 606, an unprocessed training data record is selected from the retrieved training data and provided to the trim generation system 122. The encoder transformer 402 and initially the embedding layer 403 receive the training data record and convert each token in the training data record into a vector embedding.

Sinusoidal positional encoding is be added to the input embeddings via the positional encoder 404 to provide information about the position of each token in the training data record. These positional encodings allow the encoder transformer 402 to understand the sequential order of tokens in the training data record. The input embeddings with positional encodings are then passed through the encoder layers 406, where each encoder layer includes the multi-head self-attention layer 408 followed by the feedforward neural network layer 410.

The self-attention layers 408 compute attention scores between all pairs of vector representations of tokens in the training data record. The self-attention mechanism computes weighted sums of the values based on the attention scores, resulting in contextualized representations for each token, the feedforward layer 410 learns complex interactions and features from the input representations, which are used for predicting the next token. Each encoder layer 406 transforms the input representations and enriches them with contextual information, ultimately enabling the encoder transformer 402 to generate contextual representations of the input sequence. After obtaining the token-level representations, pooled representations for each sequence are computed for the two pooling tokens. These tokens serve as a global representation of the entire sequence.

The output from the encoder transformer 402 is then fed to each of the three predictors 418, 420, and 422. Based on the initialization weights and biases, these predictors pass the input through their various neural network layers and generate outputs. For example, the classification predictor 418 generates classification labels (e.g., 0 or 1) for each frame in the training data record, the start predictor 420 generates a value between 0 and 1 as the start timing, and the end predictor 422 generates a value between 01 and 1 as the end timing.

At step 608, a loss function is determined. This is determined by comparing the predicted outputs from the three predictors with the ground truth—i.e., the actual start and end timings and the actual classification of each frame in the training data record. In case the trim generation system 122 generates each of these outputs correctly, the loss is zero. However, if any of the predicted outputs do not match the corresponding ground truths, the loss is a non-zero value. In one example, a cross-entropy loss function may be utilized for the classification predictor 418 and mean squared error function may be utilized for the start and end predictors 420, 422. In alternative embodiments, alternative loss functions may be utilised without departing from the scope of the present disclosure.

If the loss function for any of the predictors is a non-zero value, it is backpropagated through the corresponding predictor and encoder transformer 402 at step 610 to update the weights and biases of the corresponding predictor and the encoder transformer 402 and to update the embeddings of the special tokens.

The method then returns to step 604, where the next unprocessed training record is retrieved. Method 600 then repeats until all the training records are fed to the trim generation system 122. Once all the training records are used to train the trim generation system 122, a validation step may be performed where unlabelled data records are provided to the trim generation system 122 and the outputs generated by the three predictors 418-422 are compared with corresponding ground truths to determine the accuracy of the trim generation system 122. If the accuracy of the trim generation system 122 is sufficiently high (e.g., 95% or above), the training of the trim generation system 122 may end. Otherwise, if the accuracy is below a threshold level, the training of the trim generation system 122 may recommence with another set of training data records.

During training, hyperparameters of the Adam optimizer, such as the learning rate may also need to be tuned for optimal performance.

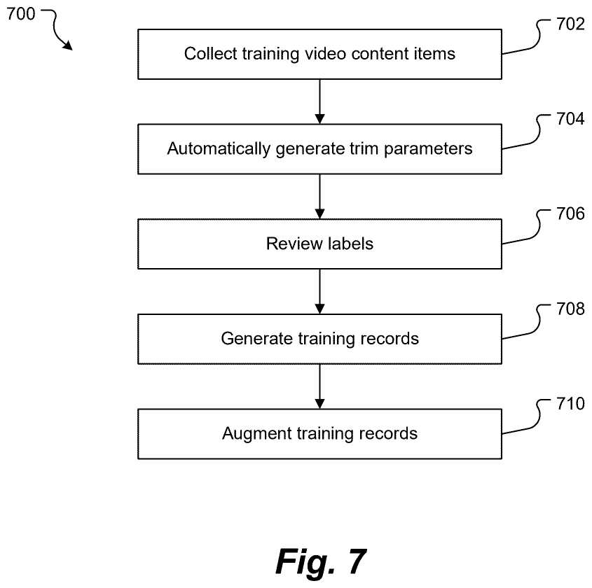

FIG. 7 illustrates an example method 700 for generating training data records for training the trim generation system 122.

The method 700 commences at step 702 where training video content items are collected. The video content items may be collected from any source—e.g., users, a video editing application, or any other suitable source. In some examples, a variety of short and long videos are collected. The short videos may be between 1-5 minutes long and the long videos may be more than 10 minutes long. Further, the videos may be of varying content type—e.g., raw home video footage, edited videos, videos with or without audio content, etc.

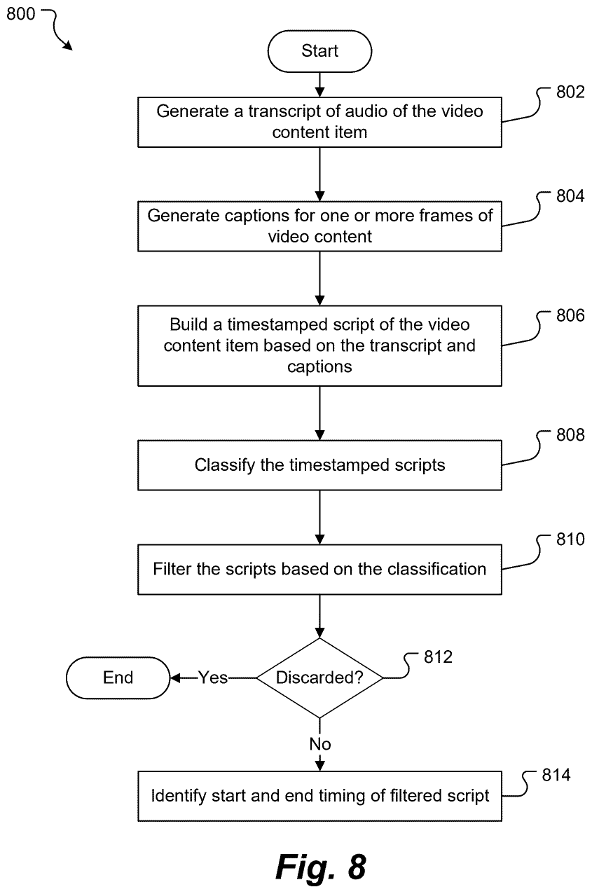

Next, at step 704, the videos are automatically labelled. In particular, trim parameters for the videos are automatically determined. The trim parameters include the start and end timing of a suitable trimmed video clip that can be generated from the corresponding video content item and in some examples also includes the classification of individual frames as being within or outside the trimmed video clip. The method for automatically generating labels is described with reference to FIGS. 8-10.

At step 706, the automatically generated labels are reviewed. In some examples, the trim labels are provided for human review via a suitable user interface. Each trim is then reviewed and adjusted, if required. Generating automatic labels significantly speeds up the labelling process. Generally, the automatic method is accurate. However, occasionally, the trim start and end times may need to be altered. The user interface displays the raw video content item and the trimmed portion determined at step 704. Users can then modify the start and/or end timing of the trimmed video clip if desired.

The method then proceeds to step 708, where the training data records are generated from the labelled video content items. As described previously, each training data record includes a start time, an end time, and vector embeddings of each frame in the corresponding video content item. Accordingly, at this step, the video content item is decoded, e.g., using the video decoder 306 to identify individual frames in the video content item. Each frame is then converted into a vector embedding. In one example, each frame is provided to a suitable encoder 308, e.g., that is configured to analyse each frame and generate a corresponding vector embedding or numerical representation of the frame. Examples of suitable encoders include a CLIP embedder. Once the frames are identified and converted into vector embeddings, a training record is generated.

At step 710, the training records are augmented. The training records may be augmented to increase the number of training records used for training the trim generation system 122 and/or to regularize the training. The training records may be augmented in two ways. In one technique, random padding is added before and after the sequence of video frames identified in the previous step. This padding helps regularize the pooling predictors such that they do not end up memorizing the values of the pooling tokens. In a second technique, random noise may be added to the vector embeddings of the frames to augment the number of training records.

FIG. 8 illustrates an example method 800 for automatically labelling training video content items. The method is described with reference to a single video content item. However, it will be appreciated that this method is performed multiple time to label all the video content items in the training set.

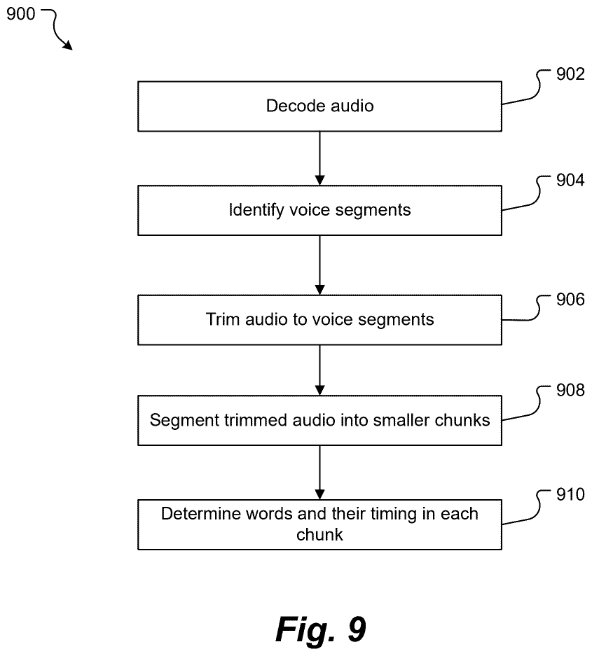

The method 800 commences at step 802 where a transcript of an audio component of the video content item is generated. The transcript includes any words spoken in the video content item along with an estimated timing of the words. The method for generating the audio transcript is described in detail with reference to FIG. 9.

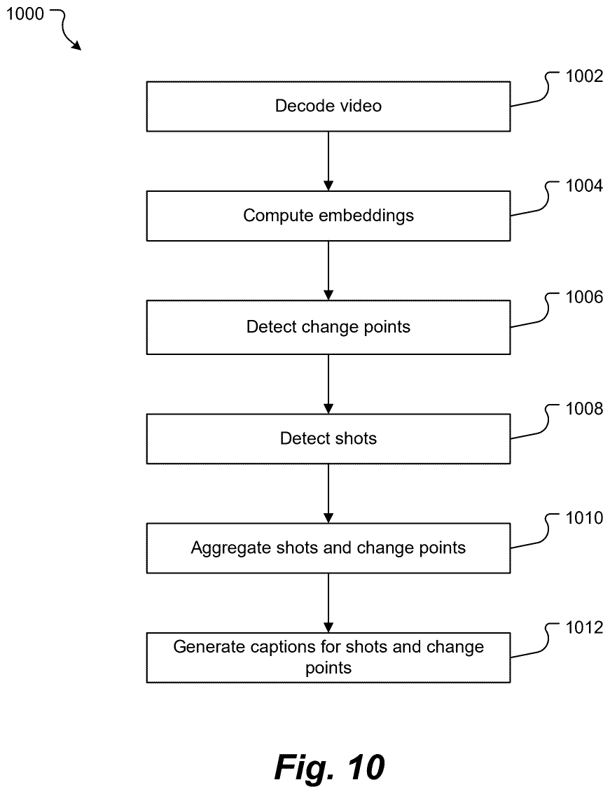

At step 804, captions are generated for one or more frames of the video content. The captions describe the images or scenes in the one or more frames. In one example, the captions may be a string of characters, e.g., 1-2 sentences that capture the essence of the scene and any action taking place in the scene. The method for generating the captions is described in detail with reference to FIG. 10.

At step 806, a timestamped script of the video content item is generated based on the transcript and the captions. In one embodiment, the script generation system 326 generates the script by combining the audio transcript and the captions. The script includes an overall caption for the video content item along with the start and end timing of the video content item, one or more dialogs and one or more captions. The dialogs are annotated with the time (in seconds) when they were spoken in the video content item, whereas the captions are annotated with the frame identifier or time corresponding to the frame the captions are related to.

An example of a timestamped script for a video related to cooking is as follows—

0.0->50: shot: 1. A chef stands in a kitchen, then the scene shifts to a
close-up of a hand interacting with food items on a table.
2.7->4.0: dialog: Hello,
4.0: caption: A chef in a white uniform stands in a kitchen with stainless
steel appliances.
4.0->8.6: dialog: my name 1s Salvador and I'm inside the kitchen Marco
Pizza
8.6->ll.2: dialog: restaurant in Malaysia.
11.2->13.5: dialog: We have a few outlets open,
13.5->15.1: dialog: Marco Pizza.
15.1->15.1: dialog: And,
15.1->19.5: dialog: honor by XYS's family.
19.5->19.7: dialog: So,
19.7->23.6: dialog: today I'm going to show you spaghetti,
20.0: caption: The chef remains in the same position, with a slight change
in facial expression.
22.0: caption: The chef begins to speak, with a subtitle appearing at the
bottom of the screen.
23.6->26.0: dialog: aglio e ollo and chili.
26.0->26.8: dialog: Spaghetti,
26.8->28.2: dialog: aglio e olio and pepperoncino.
28.2->31.9: dialog: The most important thing you need
32.0: caption: The scene changes to a close-up of a hand holding a bowl of
spaghetti.
34.3->35.8: dialog: Like you see,
35.8->38.4: dialog: very good pasta.
36.0: caption: The camera focuses on a bowl of spaghetti on a table.
38.0: caption: The hand points to the spaghetti bowl.
38.4->40.4: dialog: Garlic,
40.0: caption: The hand picks up a small amount of spaghetti.
40.4->41.8: dialog: chili.
41.8->44.6: dialog: You can use chilli flakes or red chili.
42.0: caption: The hand holds the spaghetti above the bowl.
44.0: caption: The camera pans to show a bowl of green vegetables on the
table.
44.6->45.9: dialog: Italian parsley,
46.0: caption: The camera focuses on a bowl of green vegetables, with a
bowl of spaghetti in the foreground.
45.9->47.6: dialog: salt.
47.6->50.7: dialog: And olive oil.
48.0: caption: A hand holds a bottle of olive oil over a kitchen counter
with ingredients nearby

Once the timestamped script is generated, the method proceeds to step 808, where the timestamped script is classified. In some embodiments, this includes generating a classification prompt and communicating the classification prompt to the classifier 328.

The content of the classification prompt will depend on the type of classifier 328 being used. If the classifier 328 is a general purpose LLM, the classification prompt includes the video script and configuration data, which provides instructions to the classifier 328 to classify the video script. In case the classifier 328 includes a specific ML model that has already been trained for the specific task of classifying video scripts, the classification prompt may only include the video script.

The precise format of the configuration data depends on a variety of factors, including the type of LLM (e.g., configuration data for use with OpenAI's ChatGPT may differ from the configuration data required for Google's Bard), the training mechanism of the classifier 328, and the content of the video script (and/or other available data).

In one example, the configuration data for the classification prompt may include a brief description of the task (e.g., to classify the video content item in one of a predetermined number of categories), and parameters for the task (e.g., output format, rules, etc.). The table below shows examples of configuration data that can be used.

| | |
|---|---|
| Description | To classify a video based on a video script, which is a |
| of task: | textual representation of a video |
| Parameters: | The script include shot captions which are made only when |
| | the video content changes. The content is the same until the |
| | next shot caption. |
| | The video script format is as follows - |
| | all times are in seconds, shots are annotated as “start_time |
| | → end time: shot x: description”. |
| | Captions within a shot are annotated as “time: description” |
| | Select from the following categories when classifying: |
| | Raw-singleshot footage, Edited video, Music video, TV |
| | recording, Web-cam recording, screen-recording, zoom, |
| | cartoon, still-image, presentation, video game, animation, |
| | blank. |

In this example configuration data, the parameters include instructions such as how to analyse or understand the video script and a list of categories to select from. It will be appreciated that in other examples, these parameters may be different depending on the desired format of the output required in other implementations.

In some embodiments, the same configuration data may be used to configure the classifier 328 to generate the classification prompt every time. In such cases, the configuration data may be predefined and stored as prompt data 134 in data storage 126. In other embodiments, the configuration data may vary (e.g., depending on requirements). In this case, the parameters of the configuration data may be updated to include any default overrides before the configuration data is added to the classification prompt.

The video trimming application 114 retrieves the configuration data from the data storage 126, determines whether the configuration data needs to be updated, and combines the configuration data with the video script to generate the classification prompt. In one embodiment, the video trimming application 114 generates the classification prompt by constructing a text string from one or more component parts of the configuration data and the video script (e.g. by concatenating the component parts and the video script together).

Once the classification prompt is generated, the video trimming application 114 communicates the classification prompt to the classifier 328.

By way of the configuration data, the classifier 328 is cued to generate a classification for the video content item based, in part, on the video script. The classification may be a string of text characters that describes a category of the video content item (e.g., single continuous shot, edited video, single continuous shot with speech audio, edited video with no speech audio, etc.), based in part on the video script.

The video trimming application 114 receives the classification output from the classifier 328 as a string of output text characters, referred to as a completion.

It will be appreciated that it is presumed that the configuration data is provided to the classifier 328 each time a new classification is required. However, this need not be the case in all implementations. In other implementations, the configuration data may be provided to the classifier 328 each time an instance of the classifier 328 is invoked. If the same classifier instance is then used for subsequent classification requests, the configuration data need not be submitted to the classifier 328 instance again as the classifier 328 can remember the configuration data it has been provided previously and utilize that configuration data for subsequent classification requests. Once the classifier instance is closed or exited, it may flush the configuration data and the video trimming application 114 may need to resend the configuration data along with the video script when a new instance of the classifier 328 is invoked.

Further still, it is presumed that the classifier 328 is a general purpose LLM that has not previously been trained or configured to provide classifications in the required manner. However, this need not be the case in all implementations. In some implementations, a specific purpose ML system may be adopted that has been trained using copious amounts of training data of video scripts and desired output classifications. There is no need to provide additional configuration data for such specifically trained classifiers and in such cases, the classification prompt may simply include the video script.

At step 810, the video trimming application 114 communicates the video classification to the filter 330. In some embodiments, before doing so, the video trimming application 114 may parse or process the text of the completion based on the format rules specified in the configuration data to identify the video classification. For example, it may parse the completion and identify the term “type” and then identify a string of characters following a colon (“:”) up until a carriage return. Alternative parsing, text analysis, and processing techniques are also possible to identify the classification in the classifier output.

The filter 330 examines the classification data and determines whether the corresponding video content item is to be added to a set of training data records or not at step 812. In some embodiments, the filter 330 may be provided a set of classifications or categories which are undesirable and another set of classifications or categories that are desirable. The filter then inspects the received classification and determines whether it is part of the set of desirable classifications or the set of undesirable classifications. If the filter 330 determines that the received classification is part of the desirable classifications, it adds the corresponding video content item to the set of training data records at step 812 and the method 800 proceeds to step 814. Alternatively, if the filter determines that the received classification is part of the undesirable classifications, it discards the corresponding video content item and the method 800 ends.

In some examples, undesirable classifications may include edited videos, profane or sensitive videos, videos containing speech, video having poor quality, screen recordings, etc. Examples of desirable classifications may include raw footage, single-shot footage, footage that passes content policies, high quality videos, videos that do not include any speech audio component, etc.

Once the filter 330 determines that the video content item is to be added to the set of training data records, the method proceeds to step 814, where trim parameters are determined. In some embodiments, this includes generating a trim prompt and communicating the trim prompt to the trim calculator 332.

The content of the trim prompt will depend on the type of trim calculator 332 being used. If the trim calculator 332 is a general purpose LLM, the trim prompt includes the video script and configuration data, which provides instructions to the trim calculator 332 to determine the trim parameters from the video script. In case the trim calculator 332 includes a specific ML model that has already been trained for the specific task of determining trim parameters from video scripts, the trim prompt may only include the video script.

The precise format of the configuration data depends on a variety of factors, including the type of LLM (e.g., configuration data for use with OpenAI's ChatGPT may differ from the configuration data required for Google's Bard), the training mechanism of the trim calculator 332, and the content of the video script (and/or other available data).

In one example, the configuration data for the trim prompt may include a brief description of the task (e.g., to determine the start and end time of a trimmed video clip), parameters for the task (e.g., output format, rules, etc.), and one or more training examples of video scripts and the desired trim parameters the trim calculator 332 is expected to generate based on those video scripts. The table below shows examples of configuration data that can be used.

| | |
|---|---|
| Description | Identify a trimmed video clip using the video script. The |
| of task: | trimmed video clip includes the most exciting, impactful, |
| | and/or narratively significant moments in the video. |
| Parameters: | Longer trimmed video clip is preferred. |
| | Consider the dialog and the visual impact of the shots. |
| | Prioritize moments that show action, have meaningful |
| | dialog, or some other elements of interest |
| | Do not cut off dialog |
| | Return an array of objects with ‘start_time’ (float), and |
| | ‘end_time’ (float). |
| Examples: | (see video script in the table above) |
| | Start_time: 4.0; end_time: 50.4 |

In this example configuration data, the parameters include instructions such as longer trimmed video clips are preferred, not to cut-off any dialogs, prioritizing moments that show action or have dialog, etc. It will be appreciated that in other examples, these parameters may be different depending on the desired format of the output required in other implementations.

In some embodiments, the same configuration data may be used to configure the trim calculator 332 to generate the trim prompt every time. In such cases, the configuration data may be predefined and stored as prompt data 134 in data storage 126. In other embodiments, the configuration data may vary (e.g., depending on requirements). In this case, the parameters of the configuration data may be updated to include any default overrides before the configuration data is added to the trim prompt.

The video trimming application 114 retrieves the configuration data from the data storage 126, determines whether the configuration data needs to be updated, and combines the configuration data with the video script to generate the trim prompt. In one embodiment, the video trimming application 114 generates the trim prompt by constructing a text string from one or more component parts of the configuration data and the video script (e.g. by concatenating the component parts and the video script together).

Once the trim prompt is generated, the video trimming application 114 communicates the trim prompt to the trim calculator 332.

By way of the configuration data, the trim calculator 332 is cued to generate start and end times for the video content item based, in part, on the video script. The output may be a string of objects that include the start time in a numerical value and the end time in a numerical value, based in part on the video script.

The video trimming application 114 receives the trim parameters output from the trim calculator 332 as a string of output characters, referred to as a completion.

It will be appreciated that it is presumed that the configuration data is provided to the trim calculator 332 each time a new classification is required. However, this need not be the case in all implementations. In other implementations, the configuration data may be provided to the trim calculator 332 each time an instance of the trim calculator 332 is invoked. If the same classifier instance is then used for subsequent trim requests, the configuration data need not be submitted to the trim calculator 332 instance again as the trim calculator 332 can remember the configuration data it has been provided previously and utilize that configuration data for subsequent trim requests. Once the trim calculator 332 instance is closed or exited, it may flush the configuration data and the video trimming application 114 may need to resend the configuration data along with the video script when a new instance of the trim calculator 332 is invoked.

Further still, it is presumed that the trim calculator 332 is a general purpose LLM that has not previously been trained or configured to provide trim parameters in the required manner. However, this need not be the case in all implementations. In some implementations, a specific purpose ML system may be adopted that has been trained using copious amounts of training data of video scripts and desired output trim parameters. There is no need to provide additional configuration data for such specifically trained trim calculators and in such cases, the classification prompt may simply include the video script.

The video trimming application 114 receives the trim parameters from the trim calculator 332 and generates a training data record. The training data record includes the start time, the end time, and the set of frames in the video content item. In some embodiments, the training data record may have the format described previously.

FIG. 9 illustrates an example method 900 for generating the audio transcript in method step 802. The method 900 commences at step 902, where the decoder 318 decodes an audio component of the video content item. Decoding the audio component generally includes separating the audio stream from the video stream and then converting it from its compressed format (e.g., MP3, AAC, or AC3) into a raw audio format (such as PCM). The decoder 318 may separate the audio stream from the video stream by demultiplexing the video file. Once the audio stream is extracted, the decoder 318 decodes the audio component from its compressed format. This involves reversing the encoding process that was applied during compression. Decoding reconstructs the original audio data from the compressed stream. In some embodiments, the decoder 318 may also convert the audio from one format to another at this step.

Next, at step 904, voice segments are identified in the decoded audio. This involves the activity detector 320 detecting voice activity in the decoded audio component. In some embodiments, activity detector 320 uses a voice activity detection model (VAD model). The VAD model typically starts by extracting features from the audio signal.

Feature extraction is the process of converting raw audio data into a set of representative features that can be used for subsequent analysis. This process includes pre-processing of the raw audio data, such as cleaning and formatting the data, normalizing the audio data to a standard scale, resampling the audio data in a suitable format for feature extraction, etc. Accordingly, at this step, the activity detector 320 may pre-process the audio data by, e.g., resampling, filtering or normalizing the audio data.

Thereafter, the activity detector 320 converts the pre-processed signal into a time-frequency representation, e.g., using a Short-Time Fourier Transform (STFT). While a Discrete Fourier Transform (DFT) or Fast Fourier Transform (FFT) converts a function of time into its frequency representation (the transformation is lossless and reversible), STFT is able to represent both aspects at once. This can be imagined as cutting the signal into slices with a certain “window size” and making the slices overlap by a so-called “hop size”. For each slice, the activity detector 320 computes an FFT and concatenates the results. In some embodiments, the activity detector 320 balances the frequency and time resolution by utilizing multiple spectrograms with different window sizes as features.

Windowing captures both short-term and long-term temporal variations in the audio signals. The activity detector 320 computes features for each window, and concatenates or aggregates the results (which are computed features from each window) over time to obtain the extracted features for the entire audio signal. It will be appreciated that the activity detector 320 performs various sub-processes or mathematical operations on the data at each step. The activity detector 320 may extract various different features from the audio signal at this stage. Examples of some features include time-domain features such as root mean square (RMS energy), zero-crossing rate, and temporal spread, frequency-domain features such as spectral bandwidth, Mel-frequency cepstral coefficients (MFCCs), or rhythmic pattern descriptors, etc. These features help capture important characteristics of the audio signal that are useful for distinguishing between speech and non-speech segments.

Once the features are extracted, the activity detector 320 segments the audio signal into short frames, typically around 30 milliseconds long. Each frame is then analysed independently. For each frame, the extracted features are fed into a machine learning model or signal processing algorithm that classifies the frame as either speech or non-speech. The model could be a neural network, a Hidden Markov Model (HMM), a Support Vector Machine (SVM), or other suitable classifier. The activity detector 320 then aggregates the classification results from individual frames over time to make a final decision about whether the audio segment as a whole contains speech or not. Various techniques such as majority voting, smoothing, or thresholding are applied to determine the presence or absence of speech activity.

Further, post-processing steps may be applied to refine the VAD decision. This could include filtering out short-duration speech segments, adjusting thresholds dynamically based on the noise level, or incorporating contextual information from neighbouring frames. The effectiveness of the activity detector 320 depends on factors such as the choice of features, the design of the classification algorithm, the robustness to various types of noise and interference, and the adaptability to different acoustic environments.

In one example, the activity detector may utilize a VAD model provided by PyAnnote at this step. The VAD model by PyAnnote includes similar processing steps including feature extraction, segmentation of the audio component into frames, processing each frame to predict the likelihood of speech presence, and applying post-processing techniques to refine the final VAD decision.

The output of step 904 is a classification of the audio component into segments that are predicted to include speech and segments that are predicted to be void of speech.

At step 906, this classification is provided to the trimmer 324, which is configured to trim the audio component to the voice segments identified at step 904. The output at this step is a trimmed audio component that only includes the predicted voice segments.

Next, the trimmed audio component is segmented into chunks of a predetermined duration. In one example, the trimmed audio component may be segmented into 30 second long chunks.

At step 910, the chunks are communicated to the speech recognition system 322, which is trained to determine words in each chunk. Any suitable speech recognition system 322 may be utilized at this step to detect spoken words in each chunk and to generate a transcript of the trimmed audio component based on the detected words.

In one example, the speech recognition system 322 may utilize a machine learning model that incorporates an encoder-decoder transformer architecture for word detection. Layers of the transformer are designed to automatically learn relevant audio features at different levels of abstraction. Optionally, recurrent layers like Long Short-Term Memory (LSTM) or gated recurrent units (GRUs) may be incorporated to capture temporal dependencies in the audio data.

For each chunk, the speech recognition system 322 begins by extracting features from the input audio segment. The same feature extraction process may be utilized as that utilized at step 904. Examples of features extracted by the speech recognition system 322 may include MFCCs, filter banks, and Log-MEL spectrograms. These features capture characteristics of the audio signal and serve as input to the machine learning model.

The speech recognition system 322 processes the input audio chunks frame by frame. For each frame, the extracted audio features are passed through the machine learning model, which outputs a probability distribution over target words. This probability distribution represents the machine learning model's confidence in the presence of each word in the current frame. The speech recognition system 322 may then apply thresholding to the output probabilities to determine whether each frame contains a word. If the probability of a word exceeds a predefined threshold, the frame is classified as containing the word. Otherwise, the speech recognition system 322 determines that the frame does not include any words. This process is repeated for each frame.

Based on the thresholded predictions, the speech recognition system 322 detects instances where the predicted probability of the keyword exceeds the threshold for a certain duration, indicating the presence of one or more words in the audio chunk. These detected instances represent the words spoken in the audio chunk.

The speech recognition system 322 may also apply post processing techniques to smooth the word predictions over time and reduce false positives or false negatives. Techniques such as median filtering, hysteresis, or time-domain filtering may be used to refine the keyword spotting results.

In addition to detecting words in the audio chunks, the speech recognition system also determines the timing of the words in each chunk at this step. In one embodiment, it is done by a timestamp prediction process implemented by the machine learning model. In this process, time is predicted relative to the audio chunk being processed. In some examples, the speech recognition system 322 may quantize all times to the nearest 20 milliseconds. Further, additional tokens are added to the vocabulary of the machine learning model for each of these quantized times. The timestamp prediction may be interleaved with the word predictions. That is, a start time token is predicted before word tokens are predicts by the machine learning model, and the end time token is predicted after the word tokens. In some examples, instead of predicting the start and end times for each word, the start and end time tokens are predicted for an entire audio chunk.

The output of step 910 is a timestamped transcript of the audio, which is generated based on concatenation of all the words and timing detected for each of the chunks in the trimmed audio component. An example of the timestamped audio transcript is provided in the table below

2.7-4.0: Hello,
4.0-8.6: My name is XYZ and I'm inside the kitchen ABC Pizza
8.6-11.2: restaurant in Malaysia.
11.2-13.5: we have a few outlets open,
13.5-15.1: ABC Pizza. And,
15.1-19.5: honour by XYZ's family.
19.5-23.6: so, today I'm going to show you spaghetti aglio e olio and chili.

In one example, the machine learning model utilized by the speech recognition system 322 is the Whisper model by OpenAI. In this model, the chunks of the audio are resampled to 16,000 Hz and an 80 channel log-magnitude Mel spectrogram representation is computed on 25 millisecond windows with a stride of 10 milliseconds. The Whisper model uses an encoder-decoder transformer. The encoder processes the input windows with a small stem including two convolution layers with a filter width of 3 and a GELU activation function where the second convolution layer has a stride of two. Sinusoidal position embeddings are then added to the output of the stem after which the encoder transformer blocks are applied. The transformer uses pre-activation residual blocks, and a final layer normalization is applied to the encoder output. The decoder uses learned position embeddings and tied input-output token representations. The encoder and decoder have the same width and number of transformer blocks.

FIG. 10 illustrates an example method 1000 performed by the video captioning system 302 to caption one or more frames of the video content item at step 804.

The method 1000 commences at step 1002, where the video decoder 306 decodes the video component of the video content item to extract individual frames of the video component. Decoding the video component generally includes separating the video stream from the audio stream and then converting it from its compressed format (e.g., MP4, AVI, or MKV) into a raw video format (such as PCM). The video decoder 306 may separate the video stream from the audio stream by demultiplexing the video file. Once the video stream is extracted, the video decoder 306 decodes the video component from its compressed format to reconstruct the original frames. This involves reversing the compression process that was applied during encoding.

The reconstructed frames are stored in a frame buffer or a similar data structure in memory along with frame identifiers. This buffer holds one or more frames at a time, depending on the decoding mechanism and the capabilities of the decoder. The frame identifiers may be sequential numbers that indicate the position of the frame within the video in relation to other frames in the video. For example, the frame identifier 5 indicates the fifth frame in the video and follows frame identifier 4 and is followed by frame identifier 6.

At step 1004, frame embeddings are generated for each of the reconstructed frames. To this end, each of the reconstructed frames is provided to the encoder 308. Typically, a frame embedding is a vector representation of a frame in which frames with similar motifs, colours, shapes, etc., may have similar vector profiles. Generally speaking, each number in the embedding represents information of the frame and the more numbers in an embedding, the more the information about the frame encoded into the embedding. In one example, each frame embedding may include 512 numbers. In other examples, fewer or more numbers may be included in the embedding. Image encoders of pre-trained neural networks such as contrastive language-image pretraining (CLIP), residual networks (RES-Net), vision transformer (ViT) or any other ML model capable of converting frames to vector embeddings may be utilized to obtain the frame embeddings.

In any case, the encoder 308 utilized to analyse the frames and generate the corresponding embeddings is trained such that it can represent a sufficient amount of relevant information about the frames in the embeddings. For instance, the encoder 308 may be trained by feeding an appropriate number (hundreds of thousands if not millions) of labelled images (i.e., images and their textual description). The textual descriptions may be embedded into numerical representations using techniques such as word embeddings. The images may be pre-processed by dividing them into smaller patches or tiles. Each patch is then passed through a convolutional neural network of the embedding model to extract visual features. Both the textual embeddings and the visual features extracted from the images may be projected into a shared embedding space. The embedding model is trained using contrastive learning—embeddings of matching image-text pairs are encouraged to be closer together in the embedding space, while embeddings of non-matching pairs are pushed further apart. This encourages the model to learn embeddings that capture sematic similarities between images and their associated text.

The frames may be provided to the pre-trained encoder 308 and the encoder may generate the frame embeddings. These frame embeddings may then be stored along with the frame identifiers for further processing.

Before providing the frames to the encoder 308, the video captioning system 302 may normalize the frames to preset values. This typically depends on the type of encoder 308 utilized and the requirements of the selected encoder. For example, if a CLIP encoder is utilized, frames may first be rasterized and then resized to a preset size (e.g., 224λ224).

Next (at step 1006), the video captioning system 302 detects change point frames in the video based on the frame embeddings. Change point frames indicate changes in a video. In some videos, few changes may occur. For example, consider a 60 second video of a flower blowing in the wind. In this example, the content in the video is barely changing over time. In other videos, changes may occur more frequently. For example, consider a 60 second video of a basketball game. In this example, the content in the video changes very frequently over time with a lot of action taking place in a short amount of time. Accordingly, depending on the content of the video, the number of change point frames in a video may vary. In the example of the flower video, 2-3 change point frames may be detected, whereas in the example of the basketball game, 20-30 change point frames may be detected.

In order to detect the change point frames, the vector embeddings of each frame is analysed. In particular, the change of the vector embeddings over time is analysed. If the vector embeddings of frames changes by a threshold amount between frames, a change point is detected. Alternatively, if the vector embeddings of frame change by less than a threshold amount between frames, the frames are considered relatively similar and no change point is detected.

The algorithm for detecting change includes performing pairwise comparisons between the embeddings of consecutive frames. To perform the pairwise comparisons, the vector embeddings of consecutive frames are first arranged in a matrix format, where each row corresponds to the embedding of a single frame. This results in a feature matrix where the rows represent frames and the columns represent the dimensions of the embedding space.

A kernel matrix is then computed by taking the inner product (dot product) between each pair of rows in the feature matrix. This operation calculates the similarity or dissimilarity between pairs of frames based on their embeddings. Mathematically, the kernel matrix K is computed as Kij=ϕ(embeddingᵢ)·ϕ(embeddingⱼ), Where ϕ is a feature mapping function that maps the embeddings to a higher-dimensional space where the inner product can be efficiently computed. The kernel matrix serves as the basis for similarity measurement techniques. Metrics like Euclidean distance, cosine similarity, or other similarity measures can be used for this purpose.

Next, a cost matrix can be constructed using the kernel matrix, where each element represents the cost of transitioning from one frame to another. Lower costs indicate higher similarity between frames, while higher costs indicate greater dissimilarity. This cost matrix forms the basis for dynamic programming. Dynamic programming techniques, such as the Viterbi algorithm or the Bellman-Ford algorithm, can then be applied to find the optimal sequence of change points in the video. The algorithm recursively evaluates possible change point sequences and selects the sequence with the minimum total cost. The dynamic programming algorithm may incorporate non-linear optimization techniques to handle cases where the cost function is non-linear or where additional constraints need to be enforced. This optimization step ensures that the detected change points accurately capture the significant transitions in the video. Once the optimal sequence of change points is determined, these points are considered as the locations where significant changes occur in the video content.

In one embodiment, the change points are identified based on the frame identifiers of the frames where the changes were detected. The output of this step is a set of frame identifiers corresponding to the change points.

The method 1000 then proceeds to step 1008, where the video frames are provided to the shot detector 310, which identifies shots in the video content item are identified. A shot is a continuous sequence of frames taken by a particular camera. Edited videos are generally composed of multiple shots taken from the same camera (at different positions) or from different cameras that are stitched together. Identifying shots in the video helps the video captioning system 302 to understand how the video changes in the subsequently generated video script. It also allows the video captioning system 302 to caption shots independently.

The shot detector 310 may utilize a suitable shot detection technique. In one example, the shot detector 310 may be based on the PySceneDetect process. In this example, the shot detector 310 utilizes one of several different scene detection methods to analyse video frames and identify scene changes. These methods include a threshold-based method that analyses differences in pixel intensity between adjacent frames. If the difference in pixel intensity exceeds a certain threshold, a scene change is detected. Another method is a content-based method that uses more advanced techniques, such as clustering or feature extraction, to analyse the content of frames and detect scene changes based on visual similarity. The shot detector 310 processes the video frames sequentially, comparing each frame to its adjacent frames to detect changes. For each frame, the shot detector 310 computes a metric or feature that indicates the degree of difference or similarity between frames. Based on the selected scene detection method, the shot detector 310 analyses these metrics and determines if a scene change has occurred. When a scene change is detected, the shot detector 310 records the timestamp or frame number of the change. Once scene changes are detected, the shot detector 310 generates an output file or data structure containing information about the detected scenes. This output typically includes the timestamps or frame numbers of the scene changes.

In another embodiment, the shot detector 310 may first generate an RGB tensor for each frame in the video content item and load the RGB tensors onto a graphical processing unit. An RGB tensor is a multi-dimensional array that represents a frame in the RGB (Red, Green, Blue) colour space. Each element of the tensor corresponds to the intensity of a specific colour channel (red, green, or blue) at a particular pixel in the frame. In a typical RGB tensor, the first dimension usually represents the height of the frame (number of rows), the second dimension typically represents the width of the frame (number of columns), and the third dimension represents the colour channels, with three channels for red, green, and blue, respectively. For example, a 3D RGB tensor with shape (height, width, 3) might represent a colour frame with height rows, width columns, and three colour channels. The values in the tensor usually range from 0 to 255, representing the intensity of each colour channel. A value of 0 indicates no intensity (black), while a value of 255 indicates full intensity (saturated colour).

Each RGB tensor may then be converted into floating-point. Converting an RGB tensor to floating point involves normalizing the pixel values from their original range (e.g., between 0 and 255) to a floating-point range (typically between 0.0 and 1.0 or −1.0 and 1.0).

The floating point RGB tensors are also copied and converted into HSV tensors. Converting an RGB tensor to an HSV (Hue, Saturation, Value) tensor typically involves a transformation from RGB to HSV. This transformation allows for better separation of colour information, making it easier to analyse and manipulate certain aspects of the image, such as hue and saturation.

To convert the floating point RGB to HSV, a conversion formula is applied to each floating-point value to transform each pixel value from RGB to HSV. The conversion involves calculating the hue, saturation, and value components of each pixel in the image. Hue can be computed by calculating an arctangent function applied to the ratio of green-blue and red-green differences. Saturation can be calculated as the ratio of the difference between the maximum and minimum RGB values to the maximum value and the value component (which represents the brightness of the colour) can be calculated using a suitable conversion formula.

Once the RGB and HSV tensors are generated, the RGB and HSV tensors for consecutive frames are retrieved and the differences between the RGB and HSV tensors for these consecutive frames are computed. The difference is computed as a mean or single scalar value for each pair of consecutive frames.

In one embodiment, the shot detector 310 then suppresses or discards any difference HSV values that are below a certain threshold value. This suppression highlights the frames that have high HSV difference values (indicating consecutive frames that have rapid changes in colour). These highlighted frames are further filtered based on the RGB difference values. For example, the RGB difference values for the highlighted frames are inspected. If the RGB difference values are below a threshold value (e.g., 0), these highlighted frames are also discarded. However, if the RGB difference values are above a threshold value (e.g., greater than 0), the corresponding highlighted frames are retained.

In another embodiment, the shot detector 310 first suppresses or discards any difference RGB values that are below a certain threshold value and then further filter these based on HSV difference values.

Each of the retained pairs of consecutive frames are considered shot change frames. The shot detector 310 records the timestamp or frame number of each of these shot change frames. For example, if two shot changes involves frame identifiers 6 and 7 and 18 and 19, the shot detector 310 records the frame numbers 7 and 19.

The shot detector 310 then generates an output file or data structure containing information about the detected shots. This output typically includes the timestamps or frame numbers of the shot changes.

Once shot frames and change frames are detected (at steps 1008 and 1006, respectively), the method proceeds to step 1010, where the aggregator 314 combines the shot frames and change point frames. This involves the aggregator 314 generating a combined output file or data structure that includes the frame identifiers of the frames that corresponding to each detected shot and the frame identifiers of the frames that correspond to each detected change point. In another example, the aggregator may generate different files for each shot, where each file includes the frame identifiers of the change points that are included in the corresponding shot. For example, if a shot is between frame identifiers 1 and 20 and the change point file includes frame identifiers 5, 13, and 18, the shot file for that shot includes all the change point identifiers that fall within the shot frame identifiers (that is, the frame identifiers 5, 13 and 18 in this example).

Next (at step 1010), the single or multiple combined output file(s) are utilized to retrieve embeddings of the video frames from the frame buffer that correspond to the frame identifiers in the file(s). These retrieved video frame embeddings are provided to the captioning system 316, which generates captions based on the embeddings. In one embodiment, the change point frame embeddings for each shot is provided sequentially to the captioning system 316, such that each shot is captioned one at a time. In another example, all the retrieved frame embeddings are provided to the captioning system 316 at once so that it generated captions for the various shots in parallel or at once.

In some embodiments, the captioning system 316 utilizes a vision-capable machine learning model to generate the captions. In such cases, the captioning system 316 first generates a caption prompt, which is subsequently provided to the machine learning model.

The content of the caption prompt depends on the type of machine learning model being used. If the machine learning model is a general-purpose vision-enabled LLM, the caption prompt includes the retrieved video frame embeddings and configuration data. The configuration data provides instructions to the machine learning model to generate the captions.

In case the machine learning model is a specific ML model that has already been trained for the specific task of generating captions for input video frames, the caption prompt may only include the video frame embeddings without any configuration data.

The precise format of the configuration data depends on a variety of factors, including the type of LLM (e.g., configuration data for use with a multimodal language model may differ from the configuration data required for another vision enabled LLM), the training mechanism of the machine learning model, and the content of the input data.

In one example, the configuration data for the caption prompt may include a brief description of the task (e.g., to generate captions for the video frames), parameters for the task (e.g., output format, type of captions, rules, etc.), and one or more training examples of video frames and the captions the machine learning model is expected to generate based on those examples of video frames. The table below shows examples of configuration data that can be used in the embodiment where shots are captioned one at a time.

| | |
|---|---|
| Description | Provide captions for the following frames of a single video |
| of task: | shot. Some frames have screen recordings, animations or |
| | blank screens. |
| Parameters: | Caption format *** |
| | Summary: SUMMARY |
| | Frames |
| | TIME: CAPTION*** |
| | One caption per frame |
| | Accurately describe what is happening visually. |
| | Describe the motion of the camera, keep things temporally |
| | consistent. |
| | Video frames are selected when content changes. Assume |
| | the content between frames is similar. |
| Examples: | Summary: a man plays basketball in front of his house, |
| | shoots and misses |
| | Frames |
| | 0.0: A young man in red shorts plays basketball outside a |
| | white house. The sun reflects off the ground near his feet |
| | 4.0: He faces the hoop. Basketball resting between his hand |
| | and side |
| | 8.0: He runs towards the hoop with the basketball |
| | 10.2: He shoots. He is airborne, the basketball is mid-flight |
| | 14.0: The ball bounces off the right edge of the ring |
| | 15.3: The looks at the ground, appearing sad, shoulders |
| | slumped |
| | 20.0: The basketball rolls back to his feet |

It will be appreciated that instead of the three components displayed in the table above, the configuration data may include many alternative components, and that many alternative approaches to generating a caption prompt are possible. For example, the configuration data may be (or include) a single pre-assembled prompt—e.g. a string that includes the relevant components. Alternatively, separate prompts may be generated including separate components and combinations thereof. The machine learning model can thus be configured by providing the configuration data as a prompt, part of a prompt, or series of prompts.

In some embodiments, the same configuration data may be used to configure the machine learning model to generate the captions every time. In such cases, the configuration data may be predefined and stored in the prompt data 134 in the data storage 126.

During step 1012, the captioning system 316 retrieves the configuration data from the data storage 126 and combines the configuration data with the retrieved video frame embeddings (e.g., the frames related to the shot being captioned if the shots are captioned one at a time or all the retrieved frames if the shots are captioned together) to generate the caption prompt. In one embodiment, the captioning system 316 generates the caption prompt by constructing a text string from one or more component parts of the configuration data and the video frame embeddings.

Once the caption prompt is generated, the captioning system 316 communicates the caption prompt to the machine learning model.

By way of the configuration data, the machine learning model is cued to generate the captions, in part, on the video frame embeddings. The captions may be a string of text, including a summary of the shot and the times and captions for each frame in the shot.

Once the captions are generated for all the shots identified at step 1008, the method 1000 ends.

It will be appreciated that in step 1012, it is presumed that the configuration data is provided to the machine learning model each time a new caption prompt is required. However, this need not be the case in all implementations. In other implementations, the configuration data may be provided to the machine learning model each time an instance of the machine learning model is invoked.

Further still, in step 1012, it is presumed that the machine learning model is a general-purpose vision-enabled LLM that has not previously been trained or configured to provide captions in the required manner. However, this need not be the case in all implementations. In some implementations, a specific purpose vision-enabled ML system may be adopted that has been trained using copious amounts of training data of inputs and desired output captions. In such cases, there is no need to provide additional configuration data for such specifically trained models and the caption prompt may simply include the video frame embeddings.

### Method for Using the Trim Generation System

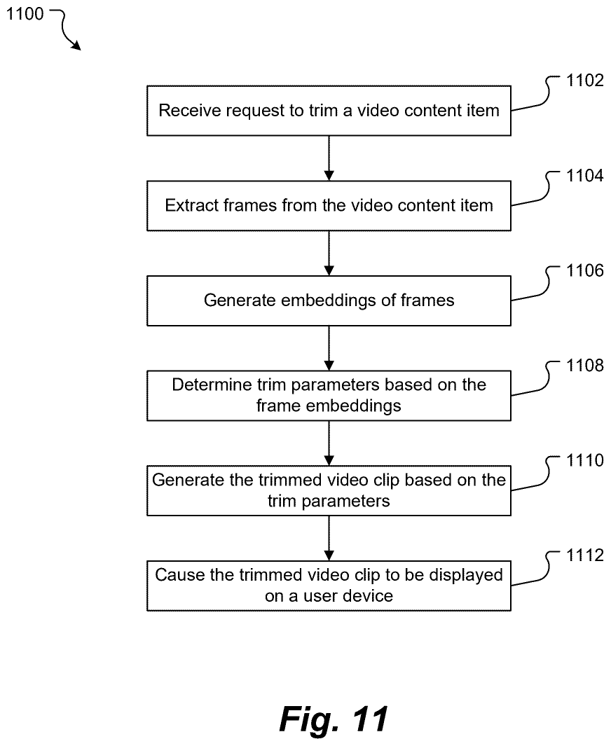

FIG. 11 illustrates an example method for automatically trimming a video content item to generate a trimmed video clip. The operations of this method will generally be described as being performed by the client application 142, the video trimming application 114, and the trim generation system 122. The operations could, however, be performed by one or more alternative applications running on the video editing server 110 and/or one or more alternative computer processing systems.

The video trimming application 114 may be configured to perform method 1100 in response to detecting one or more trigger events. As one example, the video trimming application 114 may communicate with application 142 (e.g. via network 150) to cause application 142 to display a user interface, e.g., user interface 500 displayed in FIG. 5. A user may add or otherwise upload a video using the user interface 500 and may be previewing/editing the video via the user interface 500.

In some embodiments, the method 1100 may commence when a user activates the trim control 512.

At step 1102, a request for generating a trimmed video clip is received at the video trimming application 114. In one example, once the user activates the control 512, the client application 142 creates a request for trimming the video content item currently being displayed in the preview region 502 and passes the video content item along with the request to the video trimming application 114.

At step 1104, the video trimming application decodes the received video content item to extract frames from the video. This step may be similar to step 1002 of method 1000 and therefore is not describe here again. The output of this step may be a frame buffer including the extracted frames from the video content item and their frame identifiers.

At step 1106, the frame embeddings are generated for the extracted frames. This step is similar to step 1004 of method 1000 and therefore is not described here again. The output of this step is computed frame embeddings for each of the frames in the frame buffer along with their frame identifiers.

Next (at step 1108), trim parameters are determined based on the frame embeddings. This step is performed by the trim generation system 122 that has been trained using methods 600-1000. To this end, the video trimming application 114 first generates an input record for the trim generation system 122 based on the frame embeddings computed at step 1106. In one example, the input record may include a sequence of the frame identifiers and their corresponding vector embeddings.

The input record is communicated to the trained trim generation system 122. The encoder transformer 402 of the trim generation system 122 analyses the input record and generates a rich contextual representation of the input record using non-causal self-attention mechanism that takes all the frames into account when generating the contextual representation. This contextual representation is then passed to the three predictors 418-422. Each of these predictors generates a trim parameter. In particular, the classification predictor 418 generates classifications (e.g., of either 0, indicating the frame does not form part of the trimmed video clip, or 1, indicating the frame forms part of the trimmed video clip) for each frame in the input record. The start predictor 420 generates a predicted start time for the trimmed video clip based on the output from the encoder transformer 402 and the end predictor 422 generates a predicted end time for the trimmed video clip based on the output from the encoder transformer 402.

The trim generation system 122 passes the trim parameters to the output module 118 once they are generated. At step 1110, the output module receives the trim parameters and generates the trimmed video clip based on the trim parameters. This includes generating a trimmed video clip record that includes the trim parameters and an identifier of the video content item it is associated with. The trimmed video clip record may be stored in the trim data 132 in data storage 126.

This step further includes discarding any frames that are classified as not being part of the trimmed video clip (e.g., the frames classified as 0), discarding any frames that are present in the video content item before the start time of the trimmed video clip, and discarding any frames that are present in the video content item after the end time of the trimmed video clip.

Once the frames are discarded as described above, the remaining frames are encoded to generate the trimmed video clip. This may involve compressing each retained frame of the video sequence individually using a selected video codec. Compression techniques such as spatial prediction, transform coding (e.g., discrete cosine transform, DCT), quantization, and entropy coding (e.g., Huffman coding, arithmetic coding) may be applied to reduce the size of each frame while preserving visual quality. In addition to compressing individual frames, inter-frame compression techniques may be employed to exploit temporal redundancy between consecutive frames. An encoding software (e.g., FFmpeg, HandBrake, x264, x265) is then used by the output module 118 to encode the compressed frames into a video container format such as MP4, MKV, or AVI. The encoding process involves packaging the compressed frames into a container format, adding metadata (e.g., video resolution, frame rate, audio tracks), and generating an index for efficient playback.

The generated trimmed video clip is then communicated to the client application 142 that generated the trim request (at step 1112) to render the trimmed video clip in the preview area of the user interface 500. The timeline region may also be updated by the client application 142 based on the length of the trimmed video clip.

In the above embodiments certain operations are described as being performed by the client system 140 (e.g. under control of the client application 142) and other operations are described as being performed at the video editing server 110. Variations are, however, possible. For example, in certain cases an operation described as being performed by client system 140 may be performed at the video editing server 110 and, similarly, an operation described as being performed at the video editing server 110 may be performed by the client system 140. Generally speaking, however, where user input is required such user input is initially received at client system 140 (by an input device thereof). Data representing that user input may be processed by one or more applications running on client system 140 or may be communicated to video editing server 110 for one or more applications running on the server hardware 112 to process. Similarly, data or information that is to be output by a client system 140 (e.g. via display, speaker, or other output device) will ultimately involve that system 140. The data/information that is output may, however, be generated (or based on data generated) by client application 142 and/or the video editing server 110 (and communicated to the client system 140 to be output).

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

In the above description, certain operations and features are explicitly described as being optional. This should not be interpreted as indicating that if an operation or feature is not explicitly described as being optional it should be considered essential. Even if an operation or feature is not explicitly described as being optional it may still be optional.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method for automatically generating a trimmed video clip from a video content item, the method including:
receiving a trim request from a user device, the trim request including the video content item;
determining trim parameters for the trimmed video clip, the trim parameters including a trim start time and a trim end time;
generating the trimmed video clip based on the trim parameters; and
causing display of the trimmed video clip on the user device.

2. The method of claim 1, further comprising:
decoding the video content item to extract a set of video frames from the video content item.

3. The method of claim 2, wherein the trim parameters further include classification of each video frame in the set of video frames as either being a frame within the video content item that should be included in the trimmed video clip or being a frame within the video content item that should not be included in the trimmed video clip.

4. The method of claim 1, further comprising generating vector embeddings for each frame in the set of video frames.

5. The method of claim 4, further comprising:
generating an input record comprising the vector embeddings of each frame in the set of video frames;
communicating the input record to a machine learning system trained to generate the trim parameters; and
receiving the trim parameters from the machine learning system.

6. The method of claim 5, wherein the machine learning system includes:
an encoder transformer;
a classifier predictor network trained to classify each video frame in the set of video frames as either being a frame within the video content item that should be included in the trimmed video clip or being a frame within the video content item that should not be included in the trimmed video clip;
a start predictor network trained to predict the trim start time for the trimmed video clip; and
an end predictor network trained to predict the trim end time for the trimmed video clip.

7. The method of claim 5, wherein the machine learning system is trained using an adaptive moment estimation methodology.

8. The method of claim 5, wherein training the machine learning system comprises:
initializing weights and/or biases of the machine learning system to random values;
adding special pooling tokens to a vocabulary of the machine learning system with random vector embeddings, the special pooling tokens comprising a trim start pooling token and a trim end pooling token;
providing a set of training data records to the machine learning system in a forward pass, each training data record comprising a sequence of vector embeddings of frames in a training video content item, the trim start pooling token indicating a trim start time of the training video content item, and the trim end pooling token indicating a trim end time of the training video content item;
computing a loss function for each training data record in the forward pass based on predicted output generated by the machine learning system and a corresponding ground truth; and
back propagating the loss function to the machine learning system to update the weights and/or biases of the machine learning model and the vector embeddings of the special pooling tokens based on the loss function.

9. The method of claim 8, wherein the machine learning system is trained to predict the trim start time and the trim end time using the trim start pooling token and the trim end pooling token.

10. The method of claim 1, wherein generating the trimmed video clip comprises:
discarding one or more frames from the set of frames that are present in the video content item before the trim start time; and
discarding one or more frames from the set of frames that are present in the video content item after the trim end time.

11. The method of claim 3, wherein generating the trimmed video clip further comprises:
discarding one or more frames from the set of frames that are classified as being a frame within the video content item that should not be included in the trimmed video clip.

12. The method of claim 1, wherein receiving the trim request is in response to a user activating a trim control in a user interface displayed on the user device.

13. The method of claim 10, further comprises encoding one or more frames from the video content item that are retained to generate the trimmed video clip.

14. A system for automatically generating a trimmed video clip from a video content item, the system including:
a processing unit; and
a non-transitory computer-readable storage medium storing instructions, which when executed by the processing unit, cause the processing unit to:
receive a trim request from a user device, the trim request including the video content item;
determine trim parameters for the trimmed video clip, the trim parameters including a trim start time and a trim end time;
generate the trimmed video clip based on the trim parameters; and
cause display of the trimmed video clip on the user device.

15. The system of claim 14, further comprising instructions, which when executed by the processing unit, cause the processing unit to:
decoding the video content item to extract a set of video frames from the video content item;
and wherein the trim parameters further include classification of each video frame in the set of video frames as either being a frame within the video content item that should be included in the trimmed video clip or being a frame within the video content item that should not be included in the trimmed video clip.

16. The system of claim 14, further comprising instructions, which when executed by the processing unit, cause the processing unit to:
generate vector embeddings for each frame in the set of video frames;
generate an input record comprising the vector embeddings of each frame in the set of video frames;
communicate the input record to a machine learning system trained to generate the trim parameters; and
receive the trim parameters from the machine learning system.

17. A non-transitory storage medium storing instructions executable by processing unit to cause the processing unit to:
receive a trim request from a user device, the trim request including the video content item;
determine trim parameters for the trimmed video clip, the trim parameters including a trim start time and a trim end time;
generate the trimmed video clip based on the trim parameters; and
cause display of the trimmed video clip on the user device.

18. The non-transitory storage medium of claim 17, further storing instructions, which when executed, cause the processing unit to:
decode the video content item to extract a set of video frames from the video content item;
and wherein the trim parameters further include classification of each video frame in the set of video frames as either being a frame within the video content item that should be included in the trimmed video clip or being a frame within the video content item that should not be included in the trimmed video clip.

19. The non-transitory storage medium of claim 17, further storing instructions, which when executed, cause the processing unit to:
generate vector embeddings for each frame in the set of video frames;
generate an input record comprising the vector embeddings of each frame in the set of video frames;
communicate the input record to a machine learning system trained to generate the trim parameters; and
receive the trim parameters from the machine learning system.
